(19) United States
(12) Patent Application Publication
(10) Pub. No.: US 2025/0183678 A1
(43) Pub. Date: Jun. 5, 2025

(54) BATTERY EQUALIZATION MANAGEMENT METHOD

(71) Applicant: SHENZHEN SMARTSAFE TECH CO., LTD., Shenzhen (CN)

(72) Inventors: Jun Liu, Shenzhen (CN); Wei Zhan, Shenzhen (CN)

(21) Appl. No.: 18/757,634

(22) Filed: Jun. 28, 2024

(30) Foreign Application Priority Data
Dec. 5, 2023 (CN) 202311652600.1

(51) Int. Cl. H02J 7/00; H01M 10/052; H01M 10/44; H01M 10/48

(52) U.S. Cl. CPC H02J 7/0014; H01M 10/052; H01M 10/44; H01M 10/48; H02J 7/0047

(57) ABSTRACT

Disclosed is a battery equalization management method, including the following steps: S10, setting a working period t₁ and a stopping period t₂, wherein t₁/(t₁+t₂)≥80%; S20, performing a charging and discharging operation on the battery during the working period t₁; S30, suspending the charging and discharging operation within the stopping period t₂, and performing a reverse charging and discharging operation on the battery with a small current for a preset period; S40, performing a voltage collection on the battery after the battery voltage is stable; and S50, determining whether the battery equalization is completed according to the collected battery voltage data, if yes, ending the current battery equalization operation, and if no, returning to executing steps S20 to S40. The present invention improves the accuracy and stability of battery equalization.

### CROSS REFERENCES TO RELATED APPLICATION

The present invention claims the benefit of Chinese Patent Application No. 202311652600.1 filed on Dec. 5, 2023, the contents of which are incorporated herein by reference in their entirety.

### TECHNICAL FIELD

The present invention relates to the technical field of battery equalization, and more particularly, to a battery equalization management method.

### BACKGROUND ART

With the continuous development of new energy vehicles and the continuous increase of new energy vehicle market share, battery equalization equipment for new energy vehicle has also emerged. Traditional battery equalization management system often has some limitations in battery voltage monitoring, and real battery voltage data cannot be accurately and timely collected and analyzed. Especially, the battery voltage difference can be within the required range immediately after the battery equalization, but after a period of time, the battery voltage difference becomes large, so that the equalization operation has to be performed again, which greatly affects the accuracy and stability of the battery equalization.

### SUMMARY OF THE INVENTION

The technical problem to be solved by the present invention is to provide a battery equalization management method which can improve the accuracy and stability of battery equalization.

In order to solve the above technical problem, the present invention adopts the technical solutions as follows:

A battery equalization management method includes the following steps: S10, setting a working period t₁ and a stopping period t₂, wherein t₁/(t₁+t₂)≥80%; S20, performing a charging and discharging operation on the battery during the working period t₁ to eliminate a voltage difference inside the battery; S30, suspending the charging and discharging operation within the stopping period t₂, and performing a reverse charging and discharging operation on the battery with a small current for a preset period so as to quickly stabilize a battery voltage; S40, performing a voltage collection on the battery after the battery voltage is stable to obtain an accurate battery voltage data; S50, determining whether the battery equalization is completed according to the collected battery voltage data, if yes, ending the current battery equalization operation, and if no, returning to executing steps S20 to S40.

Preferably, the small current has a current value I=(y₂−y₁)*(x−x₁)/(x₂−x₁)+y₁ in milliamps; wherein, y₁, y₂ are constants, x represents a rated voltage of the battery, x₁ represents a lower limit value of a working voltage range of the battery, and x₂ represents an upper limit value of the working voltage range of the battery.

Preferably, the battery is a lithium phosphate battery, y₁ has a value of 100, y₂ has a value of 200, x has a value of 3.7 V, x₁ has a value of 3.2 V, and x₂ has a value of 4.2 V.

Preferably, the working period t₁ is set to be 15 seconds and the stopping period t₂ is set to be 2 seconds.

Preferably, the preset period is 100 to 500 ms.

Preferably, the preset period is 150 ms.

Advantageous technical effects of the present invention are: the above-mentioned battery equalization management method improves the accuracy and stability of battery equalization by performing a periodic charging and discharging operation on the battery, and performing a reverse charging and discharging operation on the battery using a small current after the charging and discharging operation stops, so as to quickly stabilize the battery voltage; performing voltage collection on the battery so as to obtain accurate battery voltage data after the battery voltage is stabilized; and determining and adjusting and controlling the battery equalization according to the accurate battery voltage data.

### BRIEF DESCRIPTION OF THE DRAWINGS

FIG. 1 is a schematic flow diagram of a battery equalization management method of the present invention;

FIG. 2 is a graph of a battery voltage during charging of the battery;

FIG. 3 is a graph comparing a battery voltage curve at the time of stopping charging of a battery in the prior art with a battery voltage curve at the time of stopping charging of a battery in the present invention;

FIG. 4 is a graph of battery voltage during discharging of the battery; and

FIG. 5 is a graph comparing a battery voltage curve at the time of stopping discharge of a battery in the prior art with a battery voltage curve at the time of stopping discharge of a battery in the present invention.

### DETAILED DESCRIPTION OF THE INVENTION

In order to make the objects, technical solutions and advantages of the present invention more clearly understood by those skilled in the art, the present invention is further explained below with reference to the accompanying drawings and embodiments.

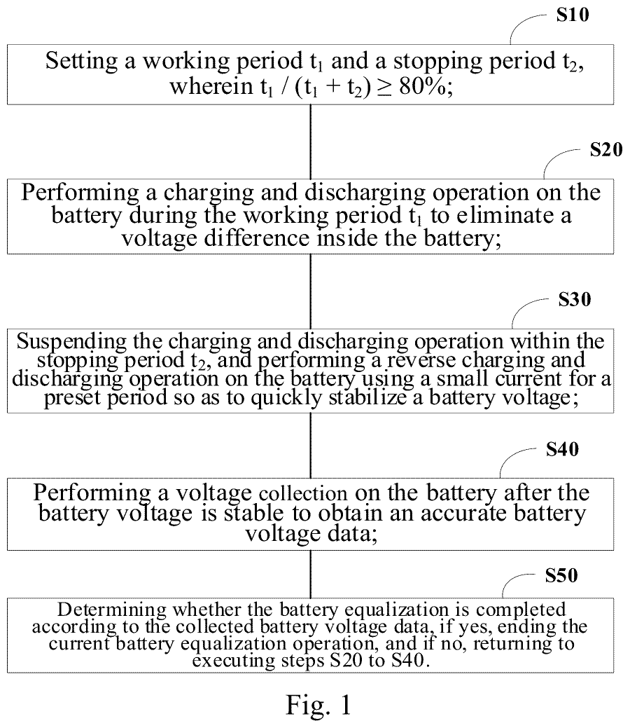

As shown in FIG. 1, in one embodiment of the present invention, a battery equalization management method includes steps S10-S50:

S10, a working period t₁ and a stopping period t₂ is set, wherein t₁/(t₁+t₂)≥80%.

In the present embodiment, the working period t₁ is set to be 15 seconds, and the stopping period t₂ is set to be 2 seconds. Of course, in other embodiments, the working period t₁ may be set to be 12 seconds, 16 seconds, or other values, and the stopping period t₂ may be set to be 3 seconds, 4 seconds, or other values, as long as t₁/(t₁+t₂)≥80% is ensured.

S20, a charging and discharging operation is performed on the battery during the working period t₁ to eliminate a voltage difference inside the battery.

The charging and discharging operation includes a charging operation or a discharging operation, and in this step, the charging operation or the discharging operation may be alternatively performed on the battery.

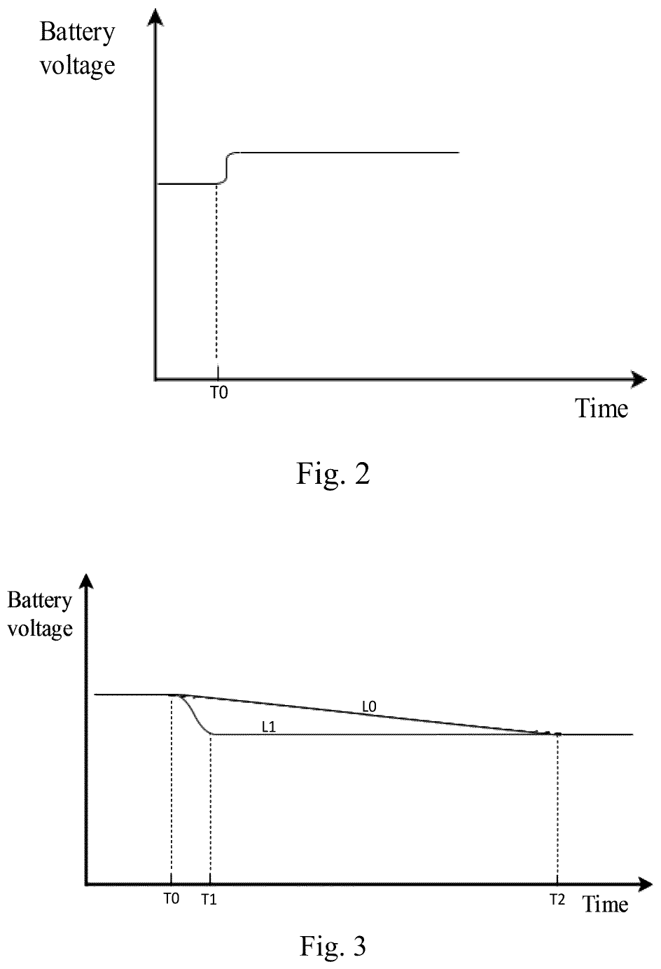

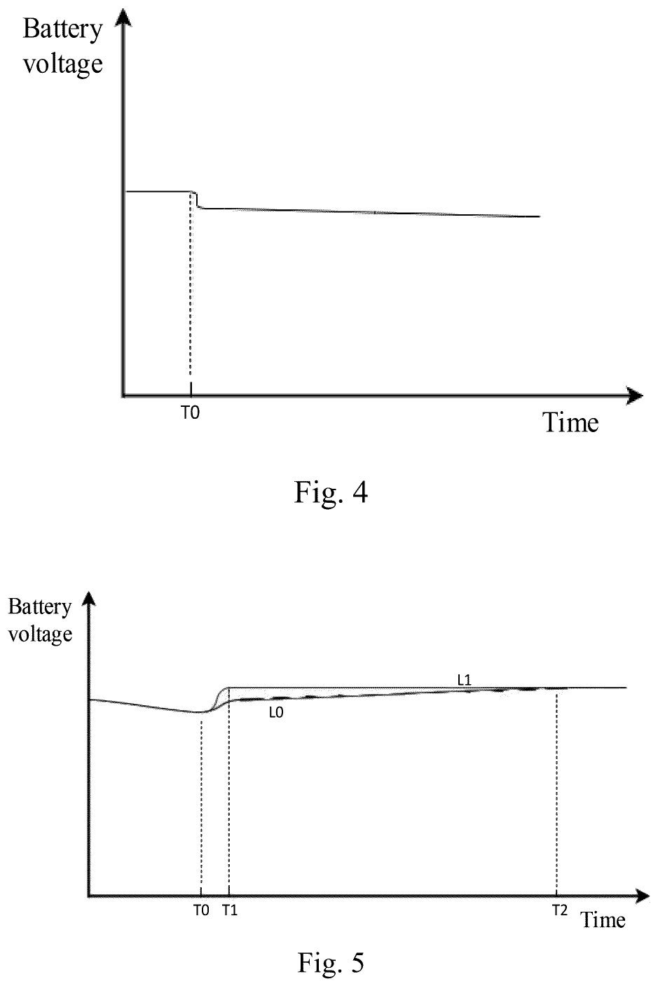

When a charging operation is performed on the battery, as shown in FIG. 2, the charging is started at a time TO, when there is a charging current, the battery voltage immediately rises, and then slowly rises with time. When the discharging operation is performed on the battery, as shown in FIG. 4, the discharging is started at time TO, when there is a discharging current, the battery voltage immediately drops, and then slowly decreases with time.

S30, the charging and discharging operation is suspended within the stopping period t₂, and a reverse charging and discharging operation is performed on the battery using a small current for a preset period so as to quickly stabilize a battery voltage.

In the present embodiment, the preset period is set to be 150 ms. Of course, in other embodiments, the preset period may be set to be 100 ms, 200 ms, 300 ms, 400 ms, 500 ms, or other values.

The small current has a current value I=(y₂−y₁)*(x−x₁)/(x₂−x₁)+y₁ in milliamps; wherein, y₁, y₂ are constants, x represents a rated voltage of the battery, x₁ represents a lower limit value of a working voltage range of the battery, and x₂ represents an upper limit value of the working voltage range of the battery. The constants y₁, y₂ may be obtained through a number of experiments, and x, x₁ and x₂ are related to the battery. In the present embodiment, the battery uses a lithium phosphate battery, wherein y₁ has a value of 100, y₂ has a value of 200, x has a value of 3.7 V, x₁ has a value of 3.2 V, and x₂ has a value of 4.2 V; therefore, the current value of the small current I=(200−100)*(3.7−3.2)/(4.2−3.2)+100=150 (milliamps).

If the battery is charged within the working period t₁, the reverse charging and discharging operation of the battery is the discharging operation of the battery. As shown by the curve L1 in FIG. 3, the charging ends at the time TO when a small current of 150 ma is added to discharge the battery for about 150 ms, and the battery voltage becomes stable at the time T1. Referring again to curve L0 in FIG. 3, the charging ends at the time T0, the battery voltage rises and does not stabilize until time T2 over a long period of time. By comparing the curve L1 and the curve L0 shown in FIG. 3, it can be seen that, at the end of charging, adding a small current of 150 ma to discharge the battery can greatly shorten the time from the end of discharging to the stabilization of the battery voltage.

If the battery is discharged within the working period t₁, a reverse charging and discharging operation is performed on the battery, i.e., a charging operation is performed on the battery. As shown by the curve L1 in FIG. 5, the discharging ends at the time T0 at which a small current of 150 ma is added to charge the battery for about 150 ms, and the battery voltage becomes stable at the time T1. Referring again to curve L0 in FIG. 5, the discharging ends at time T0, the battery voltage rises and does not stabilize until time T2 over a long period of time. By comparing the curve L1 and the curve L0 shown in FIG. 5, it can be seen that by adding a small current of 150 ma to charge the battery at the end of discharging, the time from the end of discharging to the stability of the battery voltage may be greatly shortened.

S40, a voltage collection is performed on the battery after the battery voltage is stable to obtain an accurate battery voltage data.

S50, whether the battery equalization is completed is determined according to the collected battery voltage data, if yes, ending the current battery equalization operation, and if no, returning to executing steps S20 to S40.

The battery equalization management method of the present invention improves the accuracy and stability of battery equalization by performing a periodic charging and discharging operation on the battery, and performing a reverse charging and discharging operation on the battery using a small current after the charging and discharging operation stops, so as to quickly stabilize the battery voltage; performing voltage collection on the battery so as to obtain accurate battery voltage data after the battery voltage is stabilized; and determining and adjusting and controlling the battery equalization according to the accurate battery voltage data.

The foregoing is merely a preferred embodiment of the present invention and is not intended to limit the invention in any way. Various equivalent changes and modifications can be made on the basis of the above embodiments by those skilled in the art, and all equivalent changes and modifications within the scope of the claims should be considered as falling within the protection scope of the present invention.

1. A battery equalization management method, comprising the following steps:
S10, setting a working period t₁ and a stopping period t₂, wherein t₁/(t₁+t₂)≥80%;
S20, performing a charging and discharging operation on the battery during the working period t₁ to eliminate a voltage difference inside the battery;
S30, suspending the charging and discharging operation within the stopping period t₂, and performing a reverse charging and discharging operation on the battery using a small current for a preset period so as to quickly stabilize a battery voltage;
S40, performing a voltage collection on the battery after the battery voltage is stable to obtain an accurate battery voltage data; and
S50, determining whether the battery equalization is completed according to the collected battery voltage data, if yes, ending the current battery equalization operation, and if no, returning to executing steps S20 to S40.

2. The battery equalization management method of claim 1, wherein the small current has a current value I=(y₂−y₁)*(x−x₁)/(x₂−x₁)+y₁ in milliamps; y₁, y₂ are constants, x represents a rated voltage of the battery, x₁ represents a lower limit value of a working voltage range of the battery, and x₂ represents an upper limit value of the working voltage range of the battery.

3. The battery equalization management method of claim 2, wherein the battery is a lithium phosphate battery, y₁ has a value of 100, y₂ has a value of 200, x has a value of 3.7 V, x₁ has a value of 3.2 V, and x₂ has a value of 4.2 V.

4. The battery equalization management method of claim 1, wherein the working period t₁ is set to be 15 seconds and the stopping period t₂ is set to be 2 seconds.

5. The battery equalization management method of claim 1, wherein the preset period is 100 to 500 ms.

6. The battery equalization management method of claim 5, wherein the preset period is 150 ms.
